(19) United States
(12) Patent Application Publication
(10) Pub. No.: US 2016/0326732 A1
(43) Pub. Date: Nov. 10, 2016

(54) Showerhead Attachment for Controlling the Flow and Temperature of Water

(71) Applicant: James Doyle McCormick, Salt Lake City, UT (US)

(72) Inventor: James Doyle McCormick, Salt Lake City, UT (US)

(21) Appl. No.: 15/130,221

(22) Filed: Apr. 15, 2016

Related U.S. Application Data
(60) Provisional application No. 62/157,081, filed on May 5, 2015.

(51) Int. Cl. E03C 1/05; G05D 7/06; G05D 23/19

(52) U.S. Cl. CPC E03C 1/057; G05D 23/19; G05D 7/0635

(57) ABSTRACT

A showerhead attachment for controlling the flow and temperature of water is a device that is utilized to minimize water waste and the risk of being scalded by hot water when showering. Water from a faucet or similar water source enters a casing through an inlet and exits through an outlet. A valve is positioned within a flow tube that connects the inlet and the outlet within the casing. The valve is utilized to automatically enable and disable water flow as well as to regulate the flowrate of the water. A proximity sensor detects a user's presence in the proximity of the device and water flow is disabled if the user is not detected to minimize waste. A temperature sensor is able to detect if water is too hot and water flow is automatically disabled if the water temperature is deemed unsafe.

The current application claims a priority to the U.S. Provisional Patent application Ser. No. 62/157,081 filed on May 5, 2015.

### FIELD OF THE INVENTION

The present invention relates generally to a device for increasing shower efficiency. More specifically, the present invention is a showerhead attachment for controlling the flow and temperature of water.

### BACKGROUND OF THE INVENTION

When showering, it is often desirable to temporarily shut off the water flow for a number of reasons. For example, an individual may wish to shut off the water flow to shave, apply soap, or listen for a doorbell. In conventional shower systems, water flow must typically be enabled and disabled manually, often by turning a knob to open or close a valve. The water temperature must typically be reset back to the desired level when water flow is re-enabled after being shut off. In doing this, water is wasted while the individual waits for the water temperature to reach the desired level.

The present invention is a showerhead attachment for controlling the flow and temperature of water. The present invention is mounted directly to a shower faucet and a showerhead is mounted to the present invention. Water from the shower faucet is thus able to flow through the present invention before exiting through the showerhead. The present invention detects the proximity of the user relative to the present invention and automatically enables and disables water flow. The present invention is thus able to increase the efficiency of a shower system by automatically regulating the water flow to minimize waste. When water flow is re-enabled after being temporarily disabled by the present invention, the water begins flowing at the same temperature as when the water flow was disabled. The present invention includes functionality to detect water temperature as well as to automatically shut off water flow if the water temperature reaches a user specified level (for example, to prevent scalding the skin with hot water). The present invention additionally is able to regulate the amount of water that is utilized when showering.

### BRIEF DESCRIPTION OF THE DRAWINGS

FIG. 1 is a top front perspective view of the present invention.

FIG. 2 is a top rear perspective view of the present invention.

FIG. 3 is a front view of the present invention.

FIG. 4 is a cross-sectional view of the present invention taken along line A-A of FIG. 3.

FIG. 5 is a front view of an embodiment of the present invention with at least one tubular flowrate-restricting insert.

FIG. 6 is a cross-sectional view of the present invention taken along line B-B of FIG. 5.

FIG. 7 is a front view of an embodiment of the present invention with a magnetic impeller and an electromagnetic coil.

FIG. 8 is a cross-sectional view of the present invention taken along line C-C of FIG. 7.

FIG. 9 is a diagram depicting electronic connections of the present invention.

FIG. 10 is a diagram depicting electrical connections of the present invention.

### DETAIL DESCRIPTIONS OF THE INVENTION

All illustrations of the drawings are for the purpose of describing selected versions of the present invention and are not intended to limit the scope of the present invention.

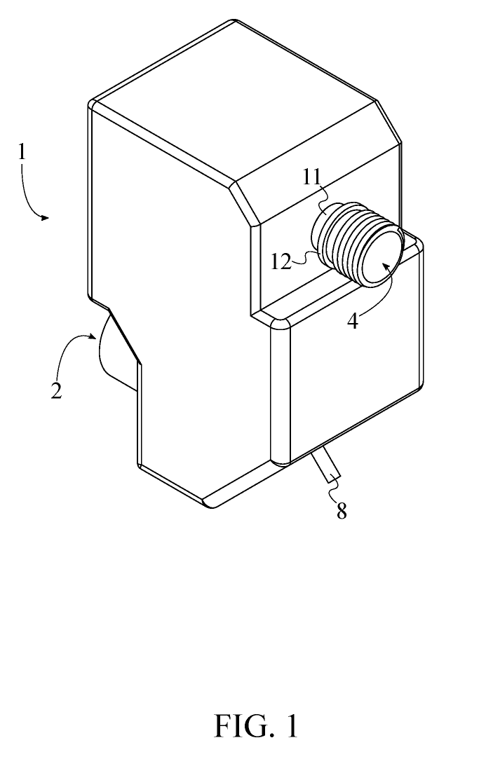

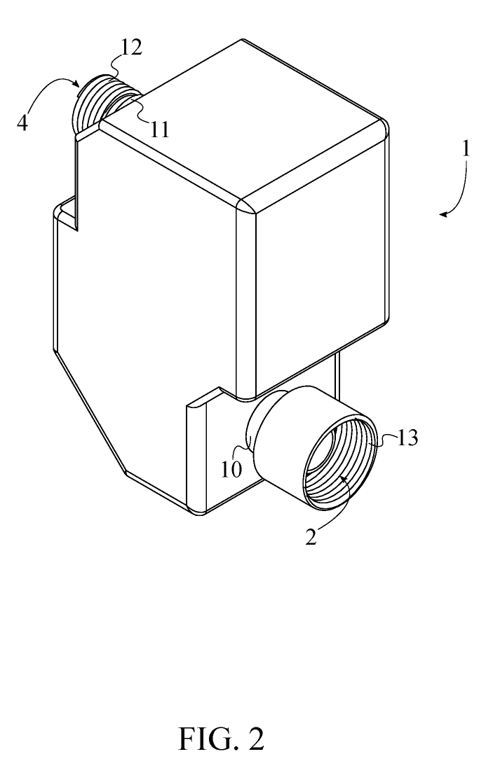

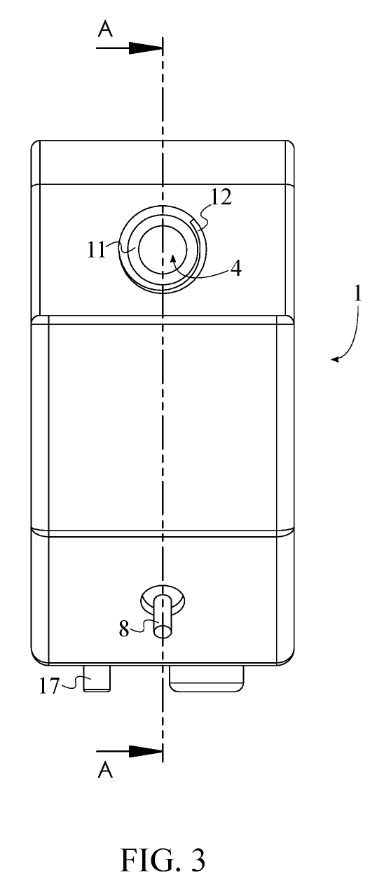

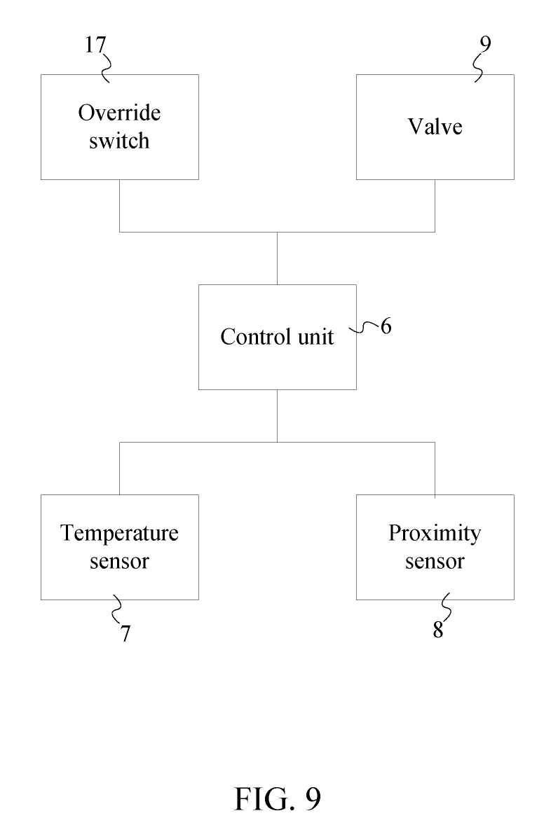

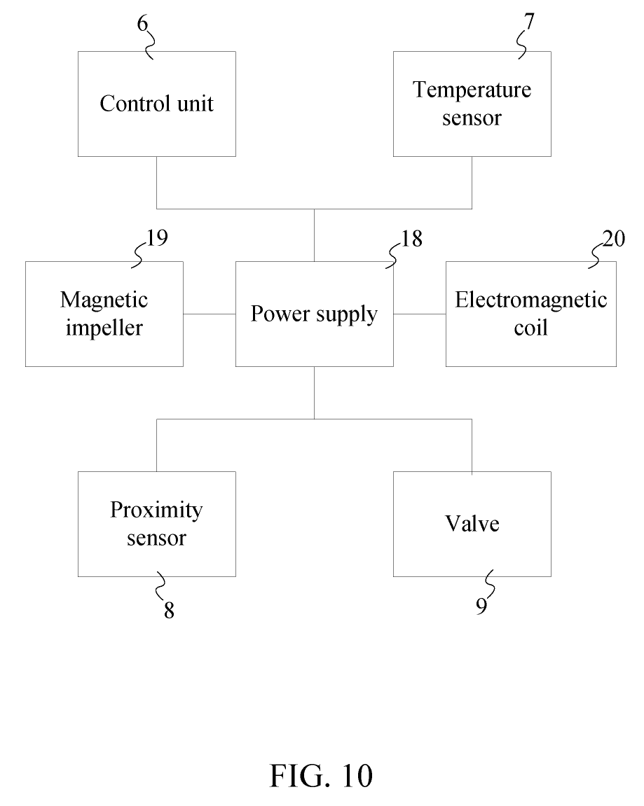

The present invention is a showerhead attachment for controlling the flow and temperature of water. The present invention increases the efficiency of a shower system by automatically shutting off the water flow if the user is not detected within an established proximity to the present invention. Water flow is resumed when the user is detected within the proximity of the present invention. The present invention is shown in FIGS. 1-8 while electronic and electrical connections of the present invention are shown in FIG. 9 and FIG. 10.

With reference to FIGS. 1-4, the present invention comprises a casing 1, a flow tube 5, a control unit 6, a temperature sensor 7, a proximity sensor 8, and a valve 9. In the preferred embodiment of the present invention, all components of the present invention are housed within or mounted onto the casing 1. The casing 1 is preferably composed of a durable material such as high-impact plastic. Water is able to flow through the casing 1 in order to control the flow and temperature of the water. The casing 1 comprises an inlet 2 and an outlet 4. Water enters the casing 1 through the inlet 2 and exits the casing 1 through the outlet 4. The inlet 2 and the outlet 4 are positioned opposite to each other on the casing 1, enabling the casing 1 to be positioned in between a faucet or similar water source and a showerhead through which water exits during a shower. The inlet 2 and the outlet 4 are preferably positioned in a manner such that a shower is not drastically altered when utilizing the present invention. Water travels through the flow tube 5 after entering the casing 1 through the inlet 2 and before exiting the casing 1 through the outlet 4. The flow tube 5 traverses through the casing 1 from the inlet 2 to the outlet 4 and thus serves as a conduit for the water from the inlet 2 to the outlet 4. The inlet 2 is in fluid communication with the outlet 4 through the flow tube 5, ensuring that water entering the casing 1 through the inlet 2 is able to reach the outlet 4 through the flow tube 5.

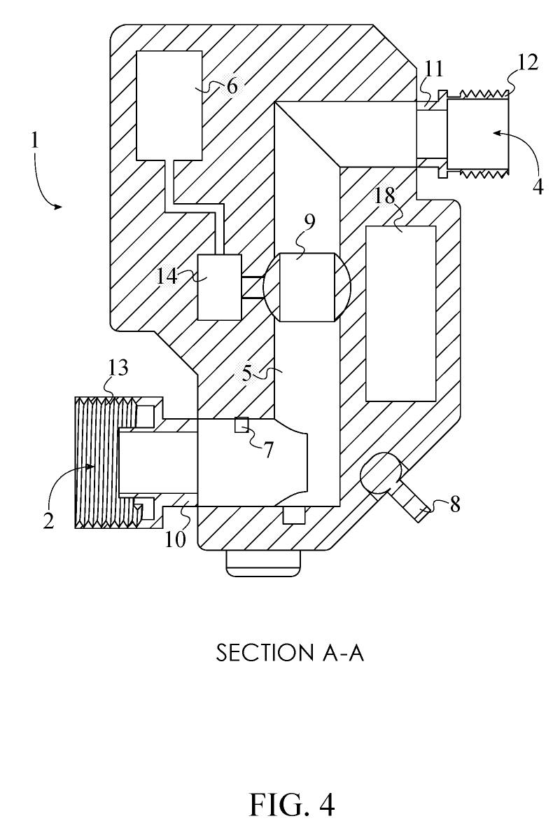

With reference to FIG. 4, the temperature sensor 7 is utilized in order to ensure that the user is not scalded by hot water during a shower. As such, the temperature sensor 7 is able to detect the temperature of water within the casing 1 before the water exits the casing 1. The temperature sensor 7 is positioned within the flow tube 5, adjacent to the inlet 2. This ensures that the valve 9 is able to restrict the flow of water within the flow tube 5 if the water is deemed too hot. The valve 9 is utilized to enable and disable water flow through the flow tube 5 as well as to regulate the flowrate of the water. In the preferred embodiment of the present invention, the valve 9 is a ball valve, although additional types of valves may be utilized as well. The valve 9 is positioned within the flow tube 5, in between the inlet 2 and the outlet 4, enabling the valve 9 to control the flow of water through the flow tube 5. The valve 9 is thus able to automatically disable water flow through the flow tube 5 if the temperature sensor 7 indicates that the water is too hot. The user may configure the temperature sensor 7 in order to establish a threshold at which the water temperature is considered too hot.

The proximity sensor 8 is able to detect the presence of the user within the proximity of the present invention and is utilized to automatically disable water flow if the user is not detected near the present invention, preventing waste of water. The proximity sensor 8 is externally positioned on the casing 1, enabling the proximity sensor 8 to detect the user's presence. The proximity sensor 8 is oriented away from the inlet 2 and is thus oriented toward the user, similar to the outlet 4. In the preferred embodiment of the present invention, the proximity sensor 8 is pivotally mounted onto the casing 1, allowing the user to adjust the orientation of the proximity sensor 8 based on the positioning of the present invention. The pivoting movement of the proximity sensor 8 may be accomplished via a ball and socket joint or similar mechanism through which the proximity sensor 8 is able to pivot when mounted on the casing 1. The user may be able to adjust the sensitivity of the proximity sensor 8 based on his or her needs. For example, the user may be able to decrease the range of the proximity sensor 8 in order to ensure that water flow is only enabled when the user is directly beside the present invention. When water flow resumes after being automatically disabled, the water temperature remains the same as prior to the water flow being disabled.

The control unit 6 is utilized to regulate the electronic and electrical components of the present invention. As such, the temperature sensor 7, the proximity sensor 8, and the valve 9 are electronically connected to the control unit 6 as shown in FIG. 9. This enables the control unit 6 to regulate many of the automated functions of the present invention such as the ability of the valve 9 to disable water flow if the water is too hot as deemed by the temperature sensor 7 and the ability of the valve 9 to disable water flow if the user is not detected by the proximity sensor 8.

Again with reference to FIGS. 1-4, the present invention further comprises a faucet mount 10 and a showerhead mount 11. The faucet mount 10 enables the present invention to be mounted to a faucet or similar water source while the showerhead mount 11 allows a showerhead to be mounted to the present invention. The faucet mount 10 is internally positioned within the inlet 2 and thus, water from a faucet or similar water source is able to enter the casing 1 through the inlet 2. The showerhead mount 11 is externally positioned on the outlet 4 and enables a showerhead to be externally mounted to the casing 1.

In its preferred embodiment, the present invention comprises a male threading 12 and a female threading 13. The male threading 12 is utilized to mount a showerhead to the present invention while the female threading 13 is utilized to mount the present invention to a faucet or similar water source. The male threading 12 is helically connected around the showerhead mount 11, allowing a showerhead to be screwed onto the showerhead mount 11 via the male threading 12. Similarly, the female threading 13 is helically connected within the faucet mount 10, allowing the present invention to be screwed onto a faucet or similar water source. The female threading 13 and the faucet mount 10 may be designed in a manner such that the present invention does not need to be rotated when screwing the present invention onto a faucet or similar water source. For example, the faucet mount 10 may be able to rotate freely and independently of the casing 1 when installing the present invention onto a faucet or similar water source.

The present invention further comprises a flowrate control switch 14 that is utilized to manually increase or decrease the flowrate of water through the flow tube 5 based on the user's needs. The flowrate control switch 14 is mechanically coupled to the valve 9, enabling the valve 9 to adjust the flowrate based on user input through the flowrate control switch 14. The flowrate control switch 14 may be a knob that is rotated in order to increase or decrease the flowrate.

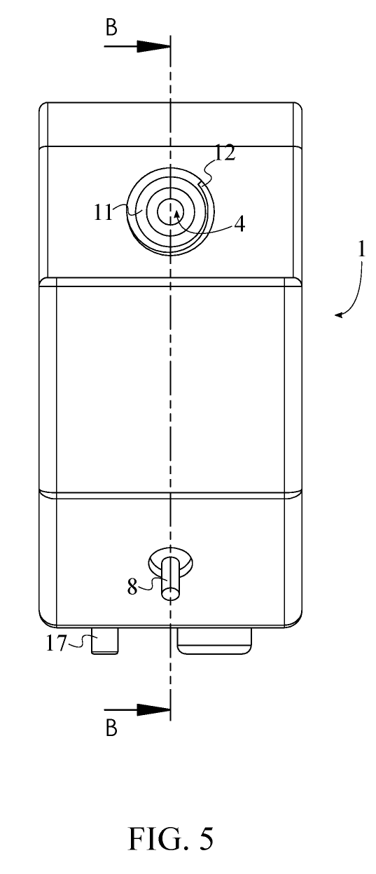

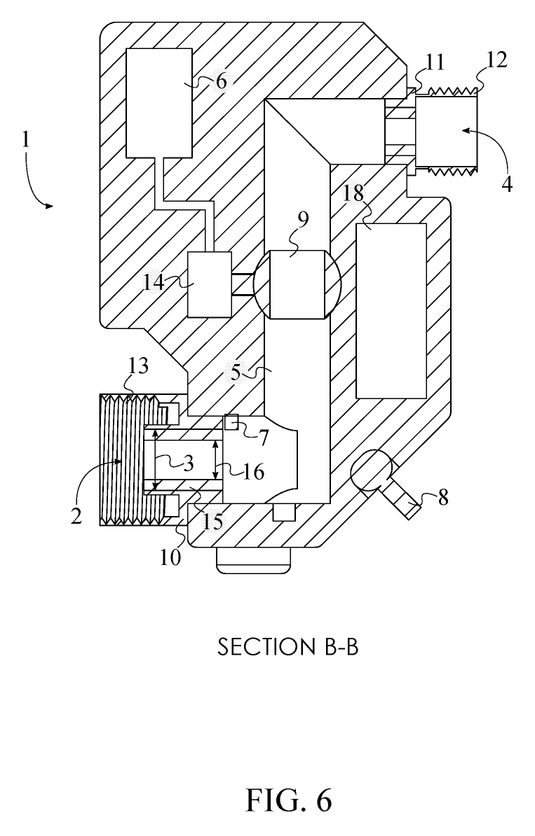

Further means of adjusting the flowrate of water through the flow tube 5 may be utilized in addition to or in lieu of the flowrate control switch 14. As shown in FIG. 5 and FIG. 6, the present invention may further comprise at least one tubular flowrate-restricting insert 15. The at least one tubular flowrate-restricting insert 15 constricts the physical space through which water is able to flow within the flow tube 5. The at least one tubular flowrate-restricting insert 15 is removably engaged into the inlet 2 and restricts the flow of water at the inlet 2. The at least one tubular flowrate-restricting insert 15 may be removed from the inlet 2 reestablish the normal flowrate. An inner diameter 16 of the at least one tubular flowrate-restricting insert 15 is smaller than a diameter 3 of the inlet 2, creating a smaller water conduit in order to restrict the flowrate of water entering the flow tube 5 through the inlet 2.

The present invention further comprises an override switch 17 that is utilized to enable or disable the functionality of the present invention. When the present invention is disabled, water flow through the present invention is unmonitored and unrestricted, much like a conventional shower without the present invention. As such, when the present invention is disabled via the override switch 17, water flow is able to proceed regardless of the water temperature and the user's presence or lack of presence in the proximity of the present invention. The override switch 17 is externally positioned on the casing 1 for convenient access by the user. The override switch 17 is electronically connected to the control unit 6, enabling the control unit 6 to disable the functionality of the present invention when user input is received through the override switch 17. The override switch 17 may be utilized to disable the present invention for any duration of time as desired by the user. For example, the override switch 17 may be tapped once in order to disable the present invention for one minute or the override switch 17 may be held down in order to disable the present invention for a longer duration of time.

The present invention further comprises a power supply 18 that provides electrical power to the electronic components of the present invention. The power supply 18 is enclosed within the casing 1 in order to prevent the power supply 18 from coming into contact with water. As shown in FIG. 10, the power supply 18 is electrically connected to the control unit 6, the temperature sensor 7, the proximity sensor 8, and the valve 9, enabling the power supply 18 to provide electrical power to the respective components.

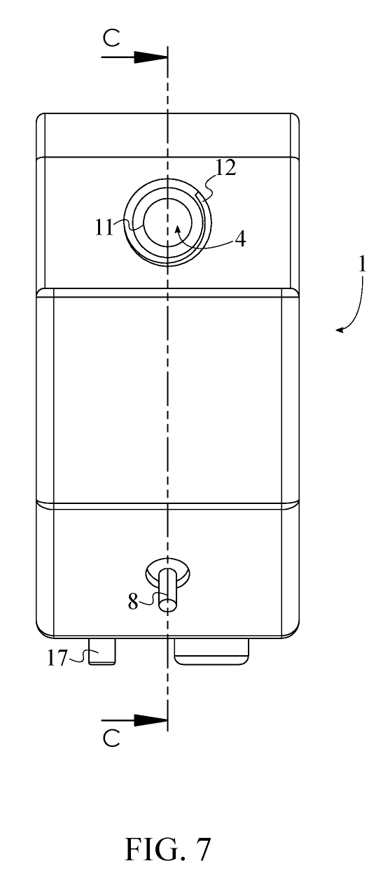

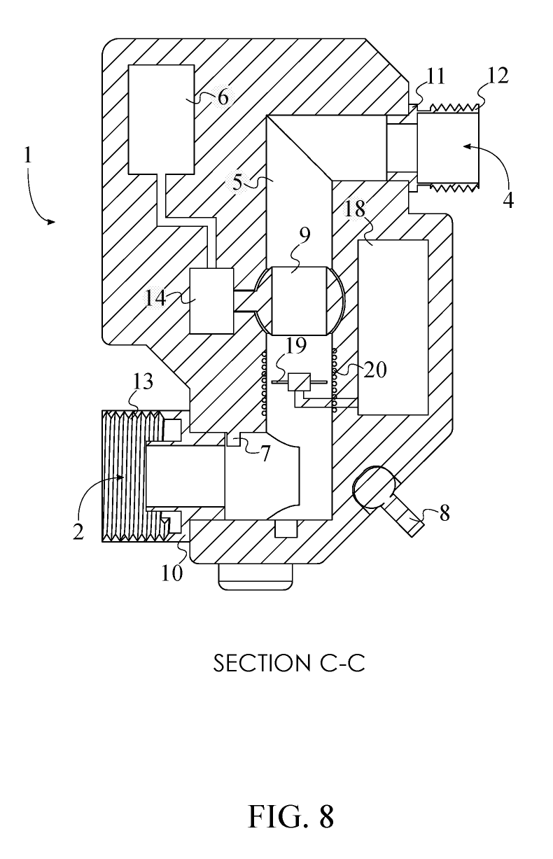

The embodiment of the present invention shown in FIG. 7 and FIG. 8 includes the ability to generate electrical power based on the water flow through the flow tube 5. This embodiment of the present invention further comprises a magnetic impeller 19 and an electromagnetic coil 20. The magnetic impeller 19 is positioned within the flow tube 5 and is oriented in a manner such that water flowing through the flow tube 5 is able to spin the magnetic impeller 19. The electromagnetic coil 20 is helically positioned around the flow tube 5, adjacent to the magnetic impeller 19. As such, the rotation of the magnetic impeller 19 within the electromagnetic coil 20 is able to generate electricity. As shown in FIG. 10, the magnetic impeller 19 and the electromagnetic coil 20 are electrically connected to the power supply 18, enabling the magnetic impeller 19 and the electromagnetic coil 20 to charge the power supply 18 based on the water flow through the flow tube 5. When sufficient electricity has been generated to power the present invention, the power supply 18 may remain in a standby mode in order to prolong life of the power supply 18.

The present invention may include additional visual displays or indicators on the exterior of the casing 1. The visual displays or indicators may provide the user with status information of the present invention including, but not limited to, power level and the presence of the user in the present invention's proximity. Additionally, the visual displays or indicators may include at least one light-emitting diode (LED) that indicates that the present invention is powered on and functional.

Although the present invention has been explained in relation to its preferred embodiment, it is understood that many other possible modifications and variations can be made without departing from the spirit and scope of the present invention as hereinafter claimed.

What is claimed is:

1. A showerhead attachment for controlling the flow and temperature of water comprises:
a casing;
a flow tube;
a temperature sensor;
a valve;
a proximity sensor;
a control unit;
the casing comprises an inlet and an outlet;
the inlet and the outlet being positioned opposite to each other on the casing;
the flow tube traversing through the casing from the inlet to the outlet;
the inlet being in fluid communication with the outlet through the flow tube;
the temperature sensor being positioned within the flow tube, adjacent to the inlet;
the valve being positioned within the flow tube, in between the inlet and the outlet;
the proximity sensor being externally positioned on the casing;
the proximity sensor being oriented away from the inlet; and
the temperature sensor, the proximity sensor, and the valve being electronically connected to the control unit.

2. The showerhead attachment for controlling the flow and temperature of water as claimed in claim 1 further comprises:
a faucet mount;
a showerhead mount;
the faucet mount being internally positioned within the inlet; and
the showerhead mount being externally positioned on the outlet.

3. The showerhead attachment for controlling the flow and temperature of water as claimed in claim 2 further comprises:
a male threading;
a female threading;
the male threading being helically connected around the showerhead mount; and
the female threading being helically connected within the faucet mount.

4. The showerhead attachment for controlling the flow and temperature of water as claimed in claim 1 further comprises:
the proximity sensor being pivotally mounted onto the casing.

5. The showerhead attachment for controlling the flow and temperature of water as claimed in claim 1 further comprises:
a flowrate control switch; and
the flowrate control switch being mechanically coupled to the valve.

6. The showerhead attachment for controlling the flow and temperature of water as claimed in claim 1 further comprises:
at least one tubular flowrate-restricting insert;
the at least one tubular flowrate-restricting insert being removably engaged into the inlet; and
an inner diameter of the at least one tubular flowrate-restricting insert being smaller than a diameter of the inlet.

7. The showerhead attachment for controlling the flow and temperature of water as claimed in claim 1 further comprises:
an override switch;
the override switch being externally positioned on the casing; and
the override switch being electronically connected to the control unit.

8. The showerhead attachment for controlling the flow and temperature of water as claimed in claim 1 further comprises:
a power supply;
the power supply being enclosed within the casing; and
the power supply being electrically connected to the control unit, the temperature sensor, the proximity sensor, and the valve.

9. The showerhead attachment for controlling the flow and temperature of water as claimed in claim 1 further comprises:
a power supply;
a magnetic impeller;
an electromagnetic coil;
the magnetic impeller being positioned within the flow tube;
the electromagnetic coil being helically positioned around the flow tube, adjacent to the magnetic impeller; and
the magnetic impeller and the electromagnetic coil being electrically connected to the power supply.

10. A showerhead attachment for controlling the flow and temperature of water comprises:
a casing;
a flow tube;
a temperature sensor;
a valve;
a proximity sensor;
a control unit;
a power supply;
a magnetic impeller;
an electromagnetic coil;
the casing comprises an inlet and an outlet;
the inlet and the outlet being positioned opposite to each other on the casing;
the flow tube traversing through the casing from the inlet to the outlet;
the inlet being in fluid communication with the outlet through the flow tube;
the temperature sensor being positioned within the flow tube, adjacent to the inlet;
the valve being positioned within the flow tube, in between the inlet and the outlet;
the proximity sensor being externally positioned on the casing;
the proximity sensor being oriented away from the inlet;
the temperature sensor, the proximity sensor, and the valve being electronically connected to the control unit;
the magnetic impeller being positioned within the flow tube;
the electromagnetic coil being helically positioned around the flow tube, adjacent to the magnetic impeller; and
the magnetic impeller and the electromagnetic coil being electrically connected to the power supply.

11. The showerhead attachment for controlling the flow and temperature of water as claimed in claim 10 further comprises:
a faucet mount;
a showerhead mount;
the faucet mount being internally positioned within the inlet; and
the showerhead mount being externally positioned on the outlet.

12. The showerhead attachment for controlling the flow and temperature of water as claimed in claim 11 further comprises:
a male threading;
a female threading;
the male threading being helically connected around the showerhead mount; and
the female threading being helically connected within the faucet mount.

13. The showerhead attachment for controlling the flow and temperature of water as claimed in claim 10 further comprises:
the proximity sensor being pivotally mounted onto the casing.

14. The showerhead attachment for controlling the flow and temperature of water as claimed in claim 10 further comprises:
a flowrate control switch; and
the flowrate control switch being mechanically coupled to the valve.

15. The showerhead attachment for controlling the flow and temperature of water as claimed in claim 10 further comprises:
at least one tubular flowrate-restricting insert;
the at least one tubular flowrate-restricting insert being removably engaged into the inlet; and
an inner diameter of the at least one tubular flowrate-restricting insert being smaller than a diameter of the inlet.

16. The showerhead attachment for controlling the flow and temperature of water as claimed in claim 10 further comprises:
an override switch;
the override switch being externally positioned on the casing; and
the override switch being electronically connected to the control unit.

17. The showerhead attachment for controlling the flow and temperature of water as claimed in claim 10 further comprises:
the power supply being enclosed within the casing; and
the power supply being electrically connected to the control unit, the temperature sensor, the proximity sensor, and the valve.
